(19) United States
(12) Patent Application Publication
(10) Pub. No.: US 2020/0117055 A1
(43) Pub. Date: Apr. 16, 2020

(54) DISPLAY DEVICE

(71) Applicant: SAMSUNG DISPLAY CO., LTD., Yongin-si (KR)

(72) Inventor: Jinhyoung KIM, Seoul (KR)

(21) Appl. No.: 16/509,185

(22) Filed: Jul. 11, 2019

(30) Foreign Application Priority Data
Oct. 11, 2018 (KR) 10-2018-0121169

(51) Int. Cl. G02F 1/1335

(52) U.S. Cl. CPC G02F 1/133606; G02F 1/133608; G02F 1/133603

(57) ABSTRACT

A display device may include a display panel including a display area and a non-display area, a light conversion member under the display panel, a light source unit under the light conversion member, and a mold frame including a first support portion supporting the display panel and a second support portion supporting the light conversion member. The first support portion and the second support portion may overlap with the non-display area when viewed in a plan view.

### CROSS-REFERENCE TO RELATED APPLICATION

This application claims priority to and the benefit of Korean Patent Application No. 10-2018-0121169, filed on Oct. 11, 2018, the entire contents of which are incorporated herein by reference.

### FIELD

Embodiments of the present disclosure relate to a display device, and for example, to a display device including a light blocking structure.

### BACKGROUND

A display device may include a display panel, a backlight unit, and a mold frame for fixing and supporting the backlight unit. The backlight unit may include a light source configured to provide blue light, and a light conversion member configured to convert the blue light into white light. However, a portion of the blue light may not pass through the light conversion member but may be provided to the display panel without passing through the light conversion member, and thus, the blue light may be visible. This may cause deterioration of display quality.

### SUMMARY

Embodiments of the present disclosure may provide a display device with improved display quality.

In an embodiment of the present disclosure, a display device may include a display panel including a display area and a non-display area, a light conversion member under the display panel, a light source unit under the light conversion member, and a mold frame including a first support portion supporting the display panel and a second support portion supporting the light conversion member. The first support portion and the second support portion may overlap with the non-display area when viewed in a plan view.

In an embodiment, the display device may further include a diffusion member between the light conversion member and the light source unit. The mold frame may further include a third support portion supporting the diffusion member.

In an embodiment, the second support portion may be between the first support portion and the third support portion when viewed in a plan view.

In an embodiment, a width of the diffusion member may be less than a width of the light conversion member.

In an embodiment, the light conversion member may include a base layer, and a first light conversion layer on the base layer. The base layer may be on the second support portion.

In an embodiment, the light conversion member may further include a second light conversion layer on a side surface of the base layer.

In an embodiment, the light conversion member may further include a light blocking portion on a side surface of the base layer.

In an embodiment, the display device may further include a light blocking member on the first support portion and the first light conversion layer.

In an embodiment, a side surface of the mold frame that joins the first support portion and the second support portion may be inclined with respect to the second support portion.

In an embodiment, at least a portion of the first support portion may overlap with at least a portion of the second support portion when viewed in a plan view.

In an embodiment, the display device may further include an optical functional layer on the side surface of the mold frame.

In an embodiment, the light conversion member may include a base layer, and a first light conversion layer under the base layer. The first light conversion layer may be on the second support portion.

In an embodiment, the display device may further include a protective layer under the first light conversion layer.

In an embodiment, the display device may further include an optical sheet between the display panel and the light conversion member. The optical sheet may be supported on the first support portion.

In an embodiment, the mold frame may have a stepped shape.

In an embodiment of the present disclosure, a display device may include a display panel, a light conversion member under the display panel, a diffusion member under the light conversion member, and a mold frame including a first support portion on which the light conversion member is supported, a second support portion on which the diffusion member is supported, and a first side surface joining the first support portion and the second support portion. A side surface of the diffusion member may face the first side surface of the mold frame.

In an embodiment, the light conversion member may include a base layer, a first light conversion layer on the base layer, and a second light conversion layer on a side surface of the base layer.

In an embodiment, the light conversion member may include a base layer, a light conversion layer on the base layer, and a light blocking portion on a side surface of the base layer.

In an embodiment, the mold frame may further include a third support portion on which the display panel is supported, and the display device may further include a light blocking member on the third support portion and the light conversion member.

In an embodiment, the mold frame may further include a third support portion on which the display panel is supported, and a second side surface joining the first support portion and the third support portion. The second side surface may be inclined with respect to the first support portion. In this case, the display device may further include an optical functional layer on the second side surface.

### BRIEF DESCRIPTION OF THE DRAWINGS

The accompanying drawings are included to provide a further understanding of the subject matter of the present disclosure, and are incorporated in and constitute a part of this specification. The drawings illustrate exemplary embodiments of the present disclosure and, together with the description, serve to explain principles of the present disclosure. In the drawings:

FIG. 1 is a perspective view illustrating a display device according to an embodiment of the present disclosure;

FIG. 2 is a cross-sectional view taken along a line X-X′ of FIG. 1 to illustrate a display device according to an embodiment of the present disclosure;

FIG. 3 is a cross-sectional view corresponding to the line X-X′ of FIG. 1 to illustrate a display device according to an embodiment of the present disclosure;

FIG. 4 is a cross-sectional view corresponding to the line X-X′ of FIG. 1 to illustrate a display device according to an embodiment of the present disclosure;

FIG. 5 is a cross-sectional view corresponding to the line X-X′ of FIG. 1 to illustrate a display device according to an embodiment of the present disclosure;

FIG. 6 is a cross-sectional view corresponding to the line X-X′ of FIG. 1 to illustrate a display device according to an embodiment of the present disclosure; and

FIG. 7 is a cross-sectional view corresponding to the line X-X′ of FIG. 1 to illustrate a display device according to an embodiment of the present disclosure.

### DETAILED DESCRIPTION

The subject matter of the present disclosure now will be described more fully hereinafter with reference to the accompanying drawings, in which various embodiments are shown. The subject matter of the present disclosure may, however, be embodied in many different forms, and should not be construed as limited to the embodiments set forth herein. Rather, these embodiments are provided so that this disclosure will be thorough and complete, and will fully convey the scope of the present disclosure to those skilled in the art. Like reference numerals refer to like elements throughout.

It will be understood that when an element such as a layer, region or substrate is referred to as being “on” another element, it can be directly on the other element or intervening elements may be present. In contrast, the term “directly” means that there are no intervening elements. As used herein, the term “and/or” includes any and all combinations of one or more of the associated listed items.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system).

Exemplary embodiments are described herein with reference to cross-sectional illustrations and/or plane illustrations that may be idealized exemplary illustrations. In the drawings, the thicknesses of layers and regions may be exaggerated for clarity. Accordingly, variations from the shapes of the illustrations as a result, for example, of manufacturing techniques and/or tolerances, may be expected. Thus, exemplary embodiments should not be construed as limited to the shapes of regions illustrated herein but are to include deviations in shapes that result, for example, from manufacturing. For example, an etching region illustrated as a rectangle may have rounded or curved features. Thus, the regions illustrated in the figures may be schematic in nature and their shapes may not illustrate the actual shape of a region of a device and are not intended to limit the scope of exemplary embodiments.

Hereinafter, exemplary embodiments of the present disclosure will be described in more detail with reference to the accompanying drawings.

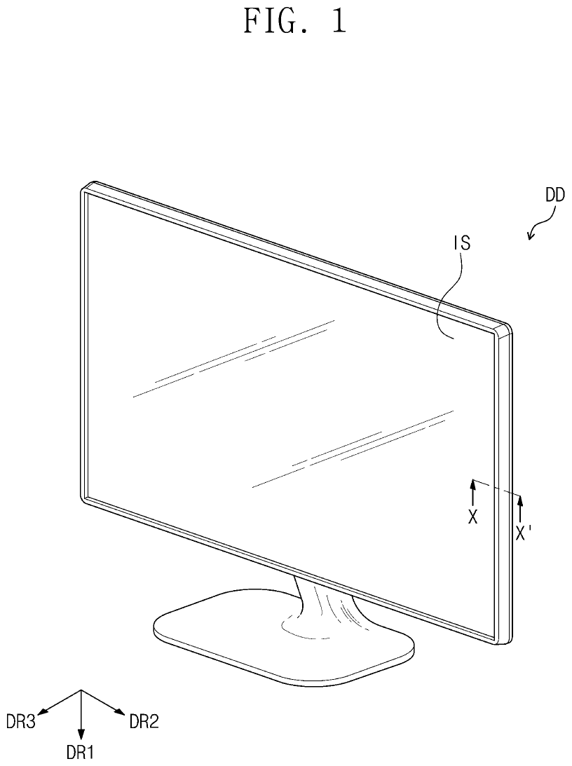

FIG. 1 is a perspective view illustrating a display device according to an embodiment of the present disclosure.

Referring to FIG. 1, a display device DD may be activated by an electrical signal. The display device DD may be realized as various suitable embodiments. In FIG. 1, a television is illustrated as an example of the display device DD. However, in other embodiments, the display device DD may also be applied to large-sized electronic devices (e.g., monitors and external billboards) and small and middle-sized electronic devices (e.g., personal computers, notebook computers, personal digital assistants (PDAs), car navigation units, game consoles, smart phones, tablets, and cameras). However, these are provided only as examples of the present disclosure, and the display device DD according to the present disclosure may also be applied to other electronic devices without departing the spirit and scope of the present disclosure.

The display device DD may provide a display surface IS on its front surface. The display surface IS may be parallel (e.g., substantially parallel) to a plane defined by a first direction DR1 and a second direction DR2. For example, the display surface IS may have a quadrilateral shape (e.g., a rectangular shape) parallel (e.g., substantially parallel) to the first and second directions DR1 and DR2. However, embodiments of the present disclosure are not limited thereto. In other embodiments, the shape of the display surface IS may be variously modified to have another suitable shape. A direction perpendicular to the display surface IS may correspond to a thickness direction DR3 (hereinafter, referred to as a third direction DR3) of the display device DD.

However, directions indicated by the first to third directions DR1, DR2 and DR3 may be relative concepts and may be changed into other directions. Hereinafter, the first to third directions are the directions indicated by the first to third directions DR1, DR2 and DR3 illustrated in FIG. 1, respectively. In the present specification, a view (or plane) defined by the first and second directions DR1 and DR2 may correspond to a plan view, and it may be understood that when one or more components are viewed in a plan view, it or they may be viewed in a direction opposite to the third direction DR3.

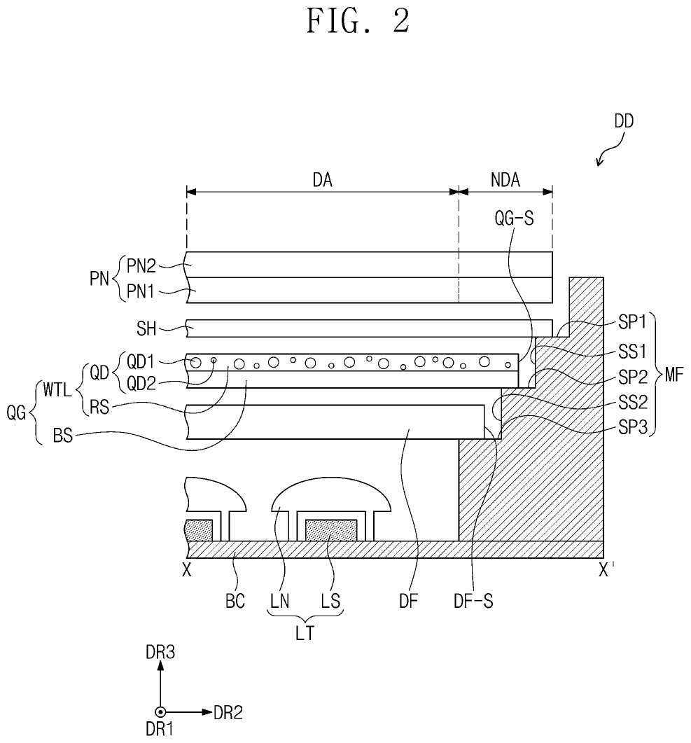

FIG. 2 is a cross-sectional view taken along a line X-X′ of FIG. 1 to illustrate a display device according to an embodiment of the present disclosure.

Referring to FIG. 2, the display device DD may include a display panel PN, an optical sheet SH, a light conversion member QG, a diffusion member DF, a light source unit LT, a back chassis BC, and a mold frame MF.

The display panel PN may display an image. For example, the display panel PN may provide the display surface IS (see FIG. 1) on its front surface. The display panel PN may be a light receiving type (or kind) of display panel. For example, the display panel PN may be a liquid crystal display panel.

The display panel PN may have a quadrilateral shape (e.g., a rectangular or substantially rectangular shape) defined by the first direction DR1 and the second direction DR2. However, embodiments of the present disclosure are not limited thereto. In other embodiments, the shape of the display panel PN may be variously modified to have another suitable shape. In some embodiments, the display panel PN may include a display substrate PN1, an opposite substrate PN2 facing the display substrate PN1, and a liquid crystal layer between the display substrate PN1 and the opposite substrate PN2.

The display panel PN may have a display area DA in which an image is displayed, and a non-display area NDA which surrounds the display area DA and in which an image is not displayed, when viewed in a plan view. The non-display area NDA may be adjacent to the display area DA. The non-display area NDA may surround the display area DA when viewed in a plan view. A driving circuit and/or driving lines for driving the display area DA may be in the non-display area NDA.

In an embodiment of the present disclosure, the display device DD may be provided in plurality to realize a large-sized display surface. In this case, when a width of the non-display area NDA is wide, a boundary between the display devices DD may be visible to a user. The probability that the boundary is visible to a user may decrease as the width of the non-display area NDA decreases.

The optical sheet SH may be under the display panel PN. The optical sheet SH may control a path of light guided from the light conversion member QG. For example, the optical sheet SH may include a diffusion sheet, a prism sheet, and a protective sheet.

The diffusion sheet may diffuse light, and the prism sheet may condense the light diffused by the diffusion sheet in such a way that a traveling direction of the diffused light becomes close to a vertical direction of the display panel PN. The protective sheet may protect the prism sheet from an external impact. In the present embodiment, the optical sheet SH includes one diffusion sheet, one prism sheet, and one protective sheet. However, embodiments of the present disclosure are not limited thereto. In other embodiments of the present disclosure, at least one of the diffusion sheet, the prism sheet or the protective sheet may be provided in plurality in the optical sheet SH or may be omitted as desired or as occasion demands. In still other embodiments, patterns may be formed on the light conversion member QG, and thus, the function of the optical sheet SH may be integrally provided to the light conversion member QG.

The light conversion member QG may be under the optical sheet SH. The light conversion member QG may guide light provided from the light source unit LT to the display panel PN and may convert a wavelength of the light.

The light conversion member QG may include a base layer BS and a light conversion layer WTL.

The base layer BS may have a rectangular shape (e.g., a substantially rectangular shape) which has two sides extending in the second direction DR2 and two sides extending in the first direction DR1 intersecting the second direction DR2. The base layer BS may receive light provided from the light source unit LT and may guide the received light toward the display panel PN. The base layer BS may be formed of glass. When the base layer BS is formed of the glass, permeation resistance of the base layer BS which inhibits, prevents, or reduces permeation of external moisture and air may be improved. In addition, the base layer BS may protect the light conversion member QG from heat. However, embodiments of the present disclosure are not limited thereto. In other embodiments, the base layer BS may include at least one selected from polyamide (PA), polymethylmethacrylate (PMMA), methyl methacrylate-styrene (MS), and polycarbonate (PC).

The light conversion layer WTL may be on a top surface of the base layer BS. The light conversion layer WTL may convert a wavelength of light provided from the light source unit LT. In more detail, the light conversion layer WTL may convert first light provided from the light source unit LT into second light. For example, the light conversion layer WTL may convert blue light provided from the light source unit LT into white light.

The light conversion layer WTL may include a resin RS and a light conversion material QD. The resin RS may be a medium in which the light conversion material QD is dispersed. The resin RS may be formed of at least one of various suitable resin composites generally referred to as binders. However, embodiments of the present disclosure are not limited thereto. A medium capable of dispersing illuminants (e.g., the light conversion material QD) may be used as the resin RS regardless of its name, additional function and/or constituent material. The resin RS may be a polymer resin. For example, the resin RS may be an acrylic-based resin, a urethane-based resin, a silicon-based resin, or an epoxy-based resin. The resin RS may be a transparent resin.

In the present embodiment, the light conversion material QD may include quantum dots. However, embodiments of the present disclosure are not limited thereto. In other embodiments, the light conversion material QD may include at least one of various other suitable materials. For example, the light conversion material QD may be a fluorescent substance.

To generate white light, the light conversion material QD may include quantum dots having different sizes on the basis of a kind of the light source unit LT. For example, the light conversion material QD may include first quantum dots QD1 and second quantum dots QD2. When the light source unit LT generates blue light, the first quantum dots QD1 may absorb light of a blue wavelength band and may emit light of a red wavelength band. The second quantum dots QD2 may absorb the light of the blue wavelength band and may emit light of a green wavelength band.

The quantum dots may be a material having a crystal structure having a size of several nanometers and may be composed of hundreds to thousands of atoms. The quantum dots may show a quantum confinement effect in which an energy band gap is increased by the small size of the quantum dots. When light of a wavelength corresponding to energy greater than the energy band gap is incident to the quantum dots, the quantum dots may be excited by absorbing the light and then may transition to a ground state while emitting light of a set or specific wavelength. Energy of the emitted light may correspond to the energy band gap. Light emitting characteristics of the quantum dots by the quantum confinement effect may be adjusted by adjusting the sizes and/or the compositions of the quantum dots.

Each of the quantum dots may have a core-shell structure including a core and a shell surrounding the core. In some embodiments, the quantum dot may have a core-shell structure in which one quantum dot surrounds another quantum dot. An interface of the core and the shell may have a concentration gradient in which a concentration of an element existing in the shell becomes progressively less toward a center.

The quantum dots may be nano-sized particles. Each of the quantum dots may have a full width of half maximum (FWHM) of an emission wavelength spectrum that is about 45 nm or less (for example, about 40 nm or less, and in more particular, about 30 nm or less), and color purity and/or color reproduction may be improved in the range. In addition, light emitted through the quantum dots may be emitted in all directions, and thus, a wide viewing angle may be improved or realized.

Furthermore, a shape of each of the quantum dots may be any suitable shape generally available in the art and is not limited to a specific shape. For example, each of the quantum dots may have a spherical shape, a pyramidal shape, a multi-arm shape, a cubic nanoparticle shape, a nanotube shape, a nanowire shape, a nanofiber shape, or a nano-plate particle shape.

The light conversion material QD may absorb the blue light provided from the light source unit LT and may convert the absorbed light into the light of the green or red wavelength band. In addition, a portion of the blue light may not be absorbed in the light conversion material QD. Thus, the blue light, the green light and the red light may be mixed with each other in the light conversion layer WTL to generate the white light.

The diffusion member DF may be under the light conversion member QG. The diffusion member DF may diffuse light. In other embodiments, a pattern may be formed at the light conversion member QG, and thus, the function of the diffusion member DF may be integrally provided to the light conversion member QG. Thus, the diffusion member DF may be omitted as needed or desired. A width of the diffusion member DF may be less than a width of the light conversion member QG.

FIG. 2 illustrates the light conversion member QG on the diffusion member DF, and the optical sheet SH on the light conversion member QG. However, embodiments of the present disclosure are not limited thereto. In another embodiment of the present disclosure, the diffusion member DF may be between the light conversion member QG and the optical sheet SH.

The light source unit LT may be under the diffusion member DF. The light source unit LT may provide light to the diffusion member DF. The light source unit LT may be provided in plurality, and the plurality of light source units LT may be arranged in the first direction DR1 and the second direction DR2.

The light source unit LT may include a light source LS and a lens LN. The light source LS may provide light to the display panel PN in which an image is displayed. For example, the light source LS may be a light emitting diode (LED). However, embodiments of the present disclosure are not limited thereto. In other embodiments, the light source LS may include at least one of various other suitable light emitting elements. The lens LN may be on the light source LS. The lens LN may disperse light provided from the light source LS. The lens LN may be a top emitting lens. However, embodiments of the present disclosure are not limited thereto. In other embodiments, the lens LN may include at least one of various other suitable lenses. For example, the lens LN may be a side emitting lens. In another embodiment of the present disclosure, the light source unit LT may not include the lens LN.

The back chassis BC may be under the light source unit LT. The back chassis BC may provide an outer surface of the display device DD and may protect the display device DD.

The mold frame MF may cover the display panel PN, the optical sheet SH, the light conversion member QG, and the light source unit LT. A portion of the mold frame MF may overlap with the non-display area NDA when viewed in a plan view.

The mold frame MF may include a first support portion SP1, a second support portion SP2, a third support portion SP3, a first side portion SS1, and a second side portion SS2.

The first support portion SP1 may support the optical sheet SH and the display panel PN. The optical sheet SH may be between the first support portion SP1 and the display panel PN.

The second support portion SP2 may support the light conversion member QG. According to an embodiment of the present disclosure, the light conversion member QG may be in close contact with the second support portion SP2. Thus, emission of light from the light source LS to the display panel PN without passing through the light conversion member QG may be prevented or reduced. As a result, a light leakage of the blue light may be reduced, and thus, the display quality of the display device DD may be improved.

The third support portion SP3 may support the diffusion member DF.

The first support portion SP1, the second support portion SP2, and the third support portion SP3 may be sequentially arranged in the second direction DR2 when viewed in a plan view. Thus, the second support portion SP2 may be between the first support portion SP1 and the third support portion SP3 when viewed in a plan view. The first side portion SS1 may be a side surface joining the first support portion SP1 and the second support portion SP2. The first side portion SS1 may face a side surface QG-S of the light conversion member QG. The second side portion SS2 may be a side surface joining the second support portion SP2 and the third support portion SP3. The second side portion SS2 may face a side surface DF-S of the diffusion member DF.

Light passing through the side surface DF-S of the diffusion member DF may be reflected or refracted at the second side portion SS2 and thus, may be incident to the light conversion member QG.

The mold frame MF may have a stepped shape when viewed in the first direction DR1. For example, the first support portion SP1, the second support portion SP2 and the third support portion SP3 may be arranged in a stepped manner.

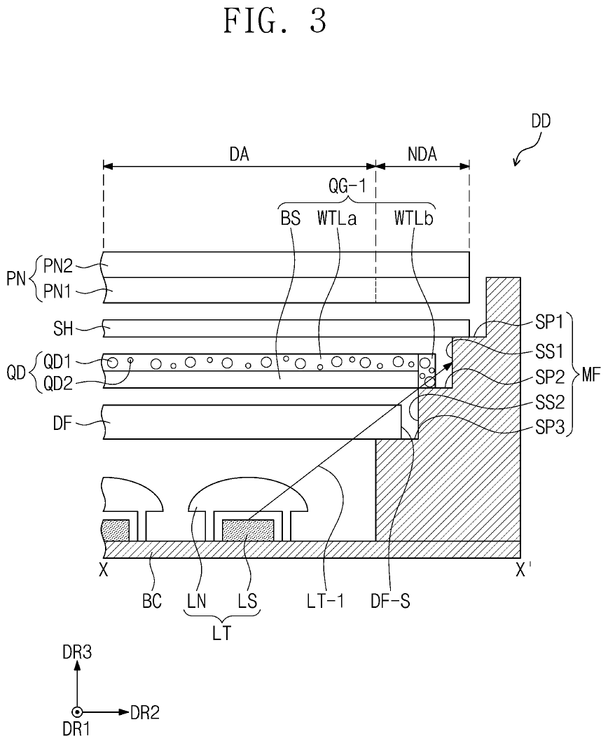

FIG. 3 is a cross-sectional view corresponding to the line X-X′ of FIG. 1 to illustrate a display device according to an embodiment of the present disclosure. In an embodiment of FIG. 3, the same components as described with reference to FIGS. 1 and 2 will be indicated by the same reference designators, and duplicative descriptions thereof will not be repeated here.

Referring to FIG. 3, a light conversion member QG-1 may include a first light conversion layer WTLa, a second light conversion layer WTLb, and a base layer BS. The first light conversion layer WTLa may be on the top surface of the base layer BS. The first light conversion layer WTLa may include substantially the same components as the light conversion layer WTL of FIG. 2. The second light conversion layer WTLb may be on a side surface of the base layer BS. The second light conversion layer WTLb may include substantially the same components as the light conversion layer WTL of FIG. 2.

First light LT-1 may be blue light emitted from the light source unit LT. The first light LT-1 may travel toward the side surface of the base layer BS. According to the present embodiment, the side surface of the base layer BS may be covered by the second light conversion layer WTLb. Thus, the first light LT-1 may pass through the second light conversion layer WTLb so as to be converted into white light. As a result, a light leakage of the blue light may be reduced, and thus, the display quality of the display device DD may be improved.

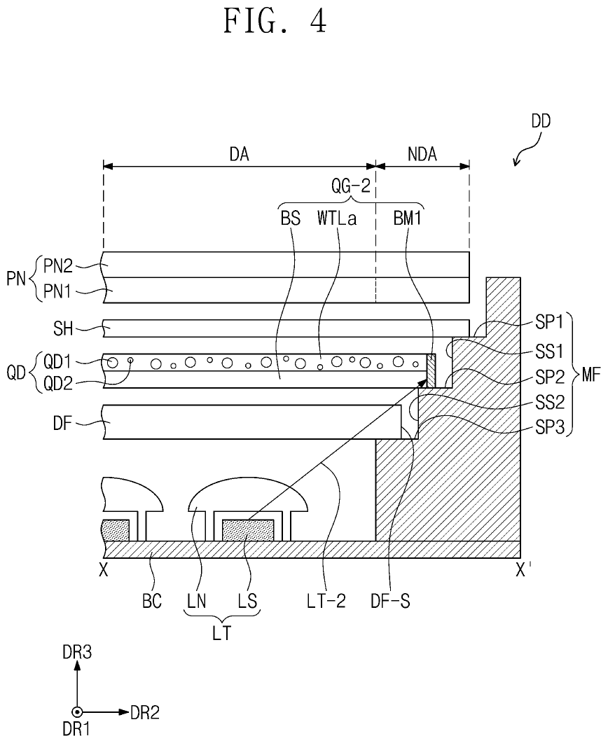

FIG. 4 is a cross-sectional view corresponding to the line X-X′ of FIG. 1 to illustrate a display device according to an embodiment of the present disclosure. In an embodiment of FIG. 4, the same components as described with reference to FIGS. 1-3 will be indicated by the same reference designators, and duplicative descriptions thereof will not be repeated here.

Referring to FIG. 4, a light conversion member QG-2 may include a first light conversion layer WTLa, a light blocking portion BM1, and a base layer BS. The first light conversion layer WTLa may be on the top surface of the base layer BS. The first light conversion layer WTLa may include substantially the same components as the light conversion layer WTL of FIG. 2. The light blocking portion BM1 may be on the side surface of the base layer BS. The light blocking portion BM1 may be at least one print layer. The light blocking portion BM1 may include tape (e.g., light blocking adhesive tape). The light blocking portion BM1 may have an opaque black color. However, embodiments of the present disclosure are not limited thereto. In other embodiments, the light blocking portion BM1 may have at least one of various other suitable colors. The light blocking portion BM1 may block light incident thereto. For example, the light blocking portion BM1 may absorb or reflect light.

Second light LT-2 may be blue light emitted from the light source unit LT. The second light LT-2 may travel toward the side surface of the base layer BS. According to the present embodiment, the side surface of the base layer BS may be covered by the light blocking portion BM1, and thus, traveling of light through the side surface of the base layer BS may be blocked reduced. As a result, a light leakage of the blue light may be reduced, and thus, the display quality of the display device DD may be improved.

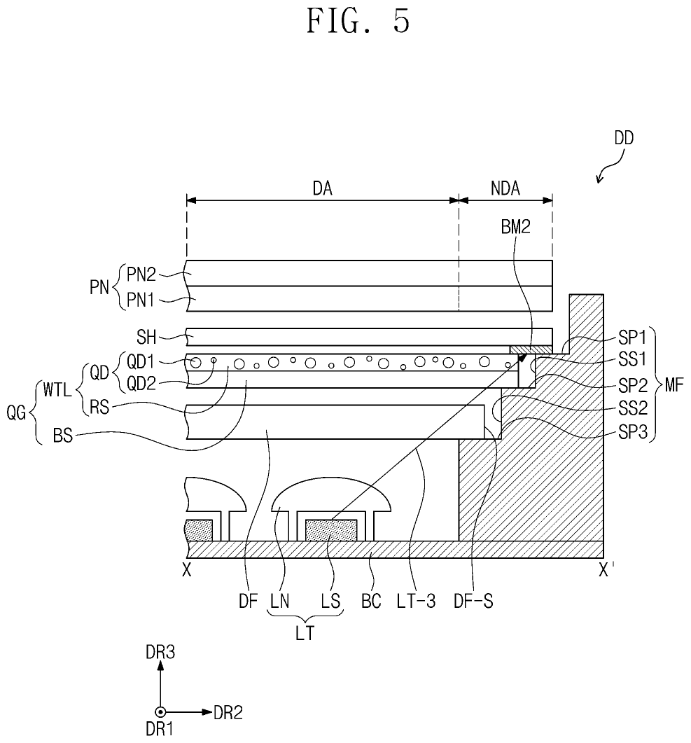

FIG. 5 is a cross-sectional view corresponding to the line X-X′ of FIG. 1 to illustrate a display device according to an embodiment of the present disclosure. In an embodiment of FIG. 5, the same components as described with reference to FIG. 2 will be indicated by the same reference designators, and duplicative descriptions thereof will not be repeated here.

Referring to FIG. 5, a display device DD may further include a light blocking member BM2 on the first support portion SP1 and the light conversion layer WTL. The light blocking member BM2 may overlap with a portion of the light conversion layer WTL and a portion of the first support portion SP1 when viewed in a plan view. The optical sheet SH and the display panel PN may be on a top surface of the light blocking member BM2. The light blocking member BM2 may include light blocking tape (e.g., light blocking adhesive tape). The light blocking member BM2 may include a material that absorbs light or a material that reflects light.

Third light LT-3 may be blue light emitted from the light source unit LT. The third light LT-3 may be light transmitted through the side surface of the base layer BS. In this case, a wavelength of the third light LT-3 may not be converted. According to the present embodiment, the third light LT-3 may be blocked by the light blocking member BM2, and thus, the third light LT-3 may not be provided to the display panel PN. As a result, a light leakage of the blue light may be reduced, and thus, the display quality of the display device DD may be improved.

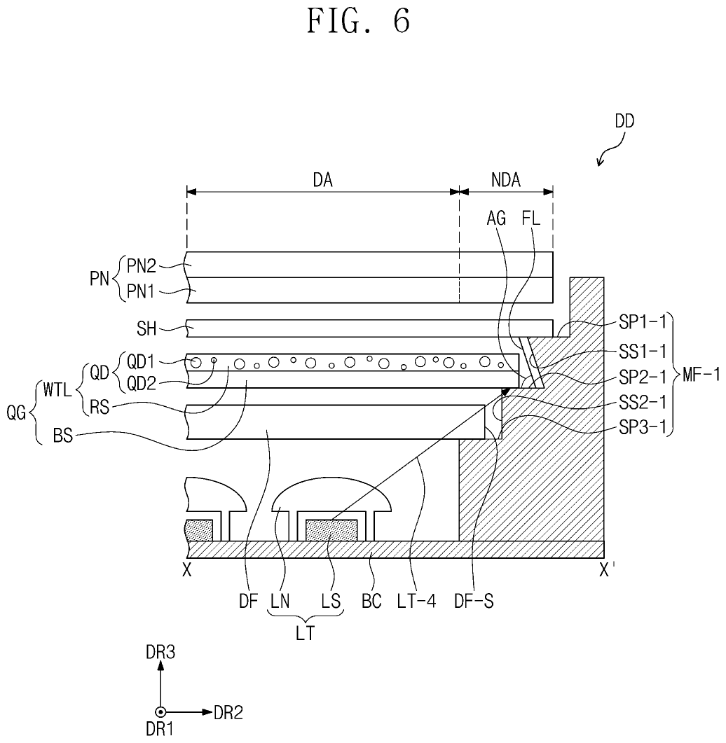

FIG. 6 is a cross-sectional view corresponding to the line X-X′ of FIG. 1 to illustrate a display device according to an embodiment of the present disclosure. In an embodiment of FIG. 6, the same components as described with reference to FIGS. 1-5 will be indicated by the same reference designators, and duplicative descriptions thereof will not be repeated here.

Referring to FIG. 6, a mold frame MF-1 may include a first support portion SP1-1, a second support portion SP2-1, a third support portion SP3-1, a first side portion SS1-1, and a second side portion SS2-1. The first side portion SS1-1 may be inclined with respect to the second support portion SP2-1. An angle AG between the first side portion SS1-1 and the second support portion SP2-1 may be an acute angle less than 90 degrees. Thus, at least a portion of the first support portion SP1-1 may overlap with at least a portion of the second support portion SP2-1 when viewed in a plan view.

Fourth light LT-4 may be blue light emitted from the light source unit LT. The fourth light LT-4 may be light transmitted through the side surface of the base layer BS. Thus, the fourth light LT-4 may be blue light. The fourth light LT-4 may be reflected or refracted from the first side portion SS1-1 and then may be incident again to the base layer BS.

An optical functional layer FL may be on the first side portion SS1-1. The optical functional layer FL may include at least one of a wavelength conversion layer, a scattering layer, or a reflective layer. However, embodiments of the present disclosure are not limited thereto. In other embodiments, the optical functional layer FL may include at least one of various other suitable components. The wavelength conversion layer may include substantially the same components as the light conversion layer WTL. Thus, the fourth light LT-4 transmitted through the wavelength conversion layer may be converted into white light. The scattering layer may include scattering particles. The fourth light LT-4 may be scattered by the scattering particles, and thus, may pass through the light conversion layer WTL. The reflective layer may be a metal layer having high reflectance. The fourth light LT-4 may be reflected by the metal layer and thus, may pass through the light conversion layer WTL. As a result, a light leakage of the blue light may be reduced, and thus, the display quality of the display device DD may be improved.

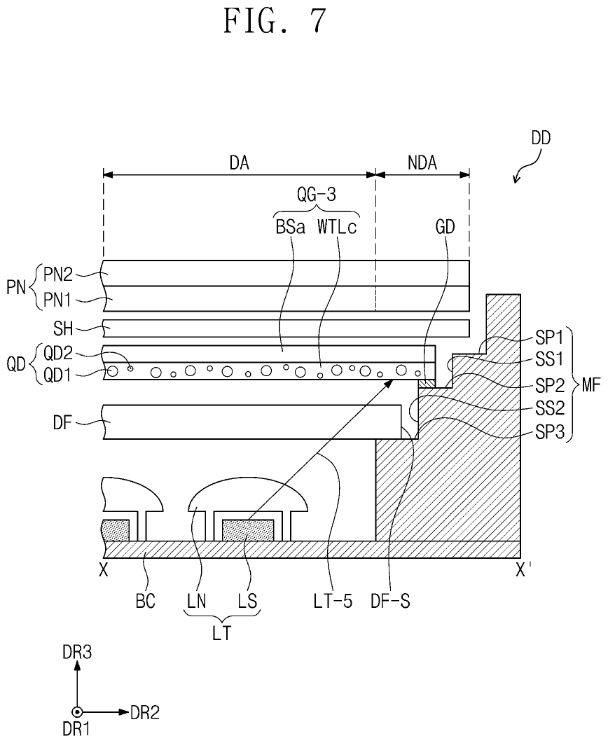

FIG. 7 is a cross-sectional view corresponding to the line X-X′ of FIG. 1 to illustrate a display device according to an embodiment of the present disclosure. In an embodiment of FIG. 7, the same components as described with reference to FIG. 3 will be indicated by the same reference designators, and duplicative descriptions thereof will not be repeated here.

Referring to FIG. 7, a light conversion member QG-3 may include a third light conversion layer WTLc and a base layer BSa. The third light conversion layer WTLc may be on a bottom surface of the base layer BSa. The third light conversion layer WTLc may include substantially the same components as the light conversion layer WTL of FIG. 2. The third light conversion layer WTLc may be on the second support portion SP2.

Fifth light LT-5 may be blue light emitted from the light source unit LT. The fifth light LT-5 may pass through the third light conversion layer WTLc so as to be converted into white light. According to the present embodiment, because the third light conversion layer WTLc is under the base layer BSa, all light passing through a side surface of the base layer BSa may be light transmitted through the third light conversion layer WTLc. As a result, a light leakage of the blue light may be reduced, and thus, the display quality of the display device DD may be improved.

The display device DD may further include a protective layer GD between the light conversion member QG-3 and the second support portion SP2. At least a portion of the protective layer GD may overlap with portions of the light conversion member QG-3 and the second support portion SP2 when viewed in a plan view. The protective layer GD may protect the light conversion member QG-3 from an external impact. For example, the protective layer GD may prevent or reduce damage of the third light conversion layer WTLc which may be caused when the third light conversion layer WTLc is in contact with the second support portion SP2. In an embodiment, the protective layer GD may be on an entire (e.g., substantially an entire) surface of the light conversion member QG-3, not a portion of the light conversion member QG-3 overlapping with the second support portion SP2. In an embodiment, the protective layer GD may be omitted.

According to the embodiments of the present disclosure, the mold frame MF of the display device DD may include the support portions SP1-SP3. The light conversion member QG may be on the top surface of the second support portion SP2. Thus, light emission from the light source unit LT to the display panel PN without passing through the light conversion member QG may be prevented or reduced. As a result, a light leakage phenomenon of blue light may be reduced, and thus, the display device DD with improved display quality may be realized.

While the subject matter of the present disclosure has been described with reference to example embodiments, it will be apparent to those skilled in the art that various changes and modifications may be made without departing from the spirit and scope of the present disclosure. Therefore, it should be understood that the above embodiments are not limiting, but illustrative. Thus, the scopes of the present disclosure are to be determined by the broadest permissible interpretation of the following claims and their equivalents, and shall not be restricted or limited by the foregoing description.

What is claimed is:

1. A display device comprising:
a display panel comprising a display area and a non-display area;
a light conversion member under the display panel;
a light source unit under the light conversion member; and
a mold frame comprising:
a first support portion supporting the display panel; and
a second support portion supporting the light conversion member,
wherein the first support portion and the second support portion overlap with the non-display area when viewed in a plan view.

2. The display device of claim 1, further comprising:
a diffusion member between the light conversion member and the light source unit,
wherein the mold frame further comprises a third support portion supporting the diffusion member.

3. The display device of claim 2, wherein the second support portion is between the first support portion and the third support portion when viewed in a plan view.

4. The display device of claim 2, wherein a width of the diffusion member is less than a width of the light conversion member.

5. The display device of claim 1, wherein the light conversion member comprises:
a base layer; and
a first light conversion layer on the base layer, and the base layer is on the second support portion.

6. The display device of claim 5, wherein the light conversion member further comprises a second light conversion layer on a side surface of the base layer.

7. The display device of claim 5, wherein the light conversion member further comprises a light blocking portion on a side surface of the base layer.

8. The display device of claim 5, further comprising:
a light blocking member on the first support portion and the first light conversion layer.

9. The display device of claim 5, wherein a side surface of the mold frame that joins the first support portion and the second support portion is inclined with respect to the second support portion.

10. The display device of claim 9, wherein at least a portion of the first support portion overlaps with at least a portion of the second support portion when viewed in a plan view.

11. The display device of claim 10, further comprising:
an optical functional layer on the side surface of the mold frame.

12. The display device of claim 1, wherein the light conversion member comprises:
a base layer; and
a first light conversion layer under the base layer, and the first light conversion layer is on the second support portion.

13. The display device of claim 12, further comprising:
a protective layer under the first light conversion layer.

14. The display device of claim 1, further comprising:
an optical sheet between the display panel and the light conversion member,
wherein the optical sheet is supported on the first support portion.

15. The display device of claim 1, wherein the mold frame has a stepped shape.

16. A display device comprising:
a display panel;
a light conversion member under the display panel;
a diffusion member under the light conversion member; and
a mold frame comprising:
a first support portion on which the light conversion member is supported;
a second support portion on which the diffusion member is supported; and
a first side surface joining the first support portion and the second support portion,
wherein a side surface of the diffusion member faces the first side surface of the mold frame.

17. The display device of claim 16, wherein the light conversion member comprises:
a base layer;
a first light conversion layer on the base layer; and
a second light conversion layer on a side surface of the base layer.

18. The display device of claim 16, wherein the light conversion member comprises:
a base layer;
a light conversion layer on the base layer; and
a light blocking portion on a side surface of the base layer.

19. The display device of claim 16, wherein the mold frame further comprises a third support portion on which the display panel is supported, and
wherein the display device further comprises a light blocking member on the third support portion and the light conversion member.

20. The display device of claim 16, wherein the mold frame further comprises:
a third support portion on which the display panel is supported; and
a second side surface joining the first support portion and the third support portion, the second side surface being inclined with respect to the first support portion, and
wherein the display device further comprises an optical functional layer on the second side surface.
